(19) United States
(12) Patent Application Publication
(10) Pub. No.: US 2007/0048722 A1
(43) Pub. Date: Mar. 1, 2007

(54) Methods and system for implementing a self-improvement curriculum

(76) Inventor: Donald Spector, New York, NY (US)

Correspondence Address: Glen M. Diehl;NORTON & DIEHL LLC, Suite 110, 77 Brant Ave., Clark, NJ, 07066, US

(21) Appl. No.: 11/213,115

(22) Filed: Aug. 26, 2005

(51) Int. Cl. G09B 3/00

(52) U.S. Cl. 434/350

(57) ABSTRACT

Methods and systems for improving an individual through a program of improvement courses are disclosed. The method of the present invention includes completing an initial assessment on a computer system prior to the individual starting the program of improvement courses and storing the completed initial assessment in a memory on the computer system and then taking the program of improvement courses. These courses are varied and combine traditional and non-traditional courses as well as eastern and western philosophies. Then one or more current assessments are computed on the computer system while taking the program of improvement courses and then stored in the memory. Once the courses are completed, one or more follow-up assessments are completed on the computer, and the results are stored in the memory. Composite scores are determined from the assessments and displayed to determine progress.

### BACKGROUND OF THE INVENTION

The present invention relates to a computer system and a method for providing an assessment of an individual's progress that results from taking a self-improvement curriculum.

There are many people that have never been taught skills needed for success in today's world. This is true whether that success is measured in monetary terms or in terms of personal satisfaction. These individuals would derive tremendous benefit from self improvement curriculums that teach some of the skills needed for success. The individuals who would benefit from such curriculums range from those individuals who have never really entered the job market and whose self-esteem is non-existent to those individuals who have steadily climbed the ladder but are missing a key ingredient to climb to the next rung on the ladder.

An integral part of such a self-improvement curriculum should be a system and method for measuring and determining the amount of improvement. Such a system should allow individuals taking courses in the curriculum to determine their self-improvement, but should also allow third parties, such as a school or an employer, to determine the level of improvement.

Accordingly, new and improved self-improvement curriculums, as well as systems and methods for assessing progress and improvement that result from taking courses in the self-improvement curriculums, are needed.

### SUMMARY OF THE INVENTION

The present invention provides a self-improvement program of courses and a method and system for implementing the self-improvement program.

In accordance with one aspect of the present invention, a method of improving an individual through a program of improvement courses is provided. The method involves completing an initial assessment on a computer system prior to an individual starting the program of improvement courses. The results of the completed initial assessment are stored in a memory on the computer system. Then, the individual begins taking courses in the self-improvement program. While taking the courses, one or more current assessments are completed on the computer system. The results of the one or more current assessments are stored in the memory.

The assessments can be completed directly on the computer system or they can be completed on a paper or other form and then entered into the computer system at a later date. A wide variety of information can be asked for by the assessment.

In accordance with one aspect of the present invention, the initial assessment and the one or more current assessments are completed by the student so that the assessment is a form of a self-assessment. In accordance with another aspect of the present invention, the assessments are completed by a third party. The third party can be the student's employer or any other person in a supervisory role with respect to the student. The third party can also be a member of a school that is offering the self-improvement program.

In accordance with a further aspect of the present invention, the program of improvement courses and the courses themselves can be modified based on the results of any of the assessments. Thus, the courses can be customizable to the student's desires and goals. Further, the courses can be customizable to the goals of the student's employer or any other person completing the assessment.

In accordance with another aspect of the present invention, the method includes the steps of computing an initial composite score from the completed initial assessment and computing a current composite score from each of the one or more current assessments. The composite scores from each of the assessments is stored in the memory.

In a further step, the composite score from the initial assessment and from the current composite scores are displayed to determine progress of the individual. The display is preferably versus time such that a rising composite score is preferably seen.

In accordance with a further aspect of the present invention, the program of improvement courses includes courses relating to physical arts, cosmeceutical sciences, nutrition, speech, writing, time management, stress management, focusing techniques and massage therapy. The program of improvement can include courses from a wide variety of disciplines, and are scientifically designed to help students improve themselves. In particular, it is the combination of these diverse courses that will help students dramatically improve themselves.

In accordance with another aspect of the present invention, the initial assessment and the current assessment includes a wide range of tests. These tests can include standard knowledge tests and psychological tests. They can also include physical tests and medical tests.

It is also desirable to follow-up with students once the program of self-improvement has been completed. Thus, one or more follow-up assessments are preferably completed on the computer after the program of improvement courses has been finished. As before, the results from the follow-up assessments are stored in the memory. Also as before, a composite score from each of the one or more follow-up assessments is preferably determined and stored in the memory. The composite scores of all of the assessments, including those from the follow-up assessments, can be displayed over time to determine the progress of the student through the self-improvement course. The follow-up assessment can be completed by the student. It can also be completed by a third party, such as an employer of the student.

### DESCRIPTION OF THE DRAWINGS

FIG. 1 illustrates a networked computer system in accordance with a first aspect of the present invention.

FIG. 2 illustrates a process in accordance with another aspect of the present invention.

FIG. 3 illustrates an exemplary assessment form in accordance with the present invention which may completed in paper form or on a computer.

FIG. 4 illustrates a determination of a composite score from an assessment form in accordance with a further aspect of the present invention.

FIG. 5 illustrates a display of composite scores from a plurality of assessments taken over time.

### DESCRIPTION OF A PREFERRED EMBODIMENT

One aspect of the present invention provides a program of courses designed to improve individuals in various ways. The program or curriculum will include a unique combination of courses as well as a unique assessment program to allow individuals to improve themselves. The program will include courses on eastern and western techniques, medical follow ups, physical arts, psychology, cosmeceutical techniques, neutraceutical techniques, nutrition, stress management, a combination of didactic courses and laboratory courses in which the student is the subject as well as an active participant in techniques.

In one aspect of the present invention, students will complete a computer based assessment program that inquires as to the student's goals, and the student, in response, specifies those goals. The program will also preferably include tests that assess the current status of the student. These tests can provide traditional tests that test knowledge, as well as tests that test the psychological state and the physical state of the student. Based on the goals specified by the student, the current status of the student and the available courses, the program will provide a suggested series of courses to take. The assessment program also preferably provides a set of goals for the student to reach.

This program of courses and assessments will assist students in getting better jobs, increasing productivity in current jobs, increase employer's ability to retain employees and decrease employee burnout. The program will be useful to a wide range of students, including students of all ages.

The program is preferably a curriculum that is tailored and that provides content to the individual students and their personal objectives. This can be accomplished by assessment programs that are administered before the program starts, at various times during the program, at the conclusion of the program and as part of a follow up to the program.

The program preferably uses traditional as well as programmed learning techniques. Long distance learning techniques, such as on line courses, will also be preferably provided. Some of the aspects of the program, however, may require the presence of a student, and long distance learning may not be appropriate in those cases.

The program provided to students preferably includes courses on self-improvement science psychology, meditation, yoga, tai chi, other physical arts, cosmeceutical sciences, speech therapy, fashion (including corporate fashion), writing improvement, vocabulary, organization, time management, stress management, focusing techniques, message therapy, acupuncture, herbal medicine, nutrition. A self-assessment program can also be provided as a course, however, self assessment is preferably an integral part of the program. Thus, self-assessment programs are preferably completed by the student at every step of the program, as well as before and after the program. Other assessment programs to be completed by third parties are also preferably an integral part of the program. This includes assessment programs completed by third parties, such as the student's employer, before, during and after the program. Assessment programs are also preferably completed by the school before, during and after the program.

These courses are preferably interactive and also customizable. Thus, students will participate in the courses in an interactive way. For example, with massage courses, the students can both receive massages and give massages. Further, the courses are also customizable based on student specific goals, thereby helping students attain their goals quicker.

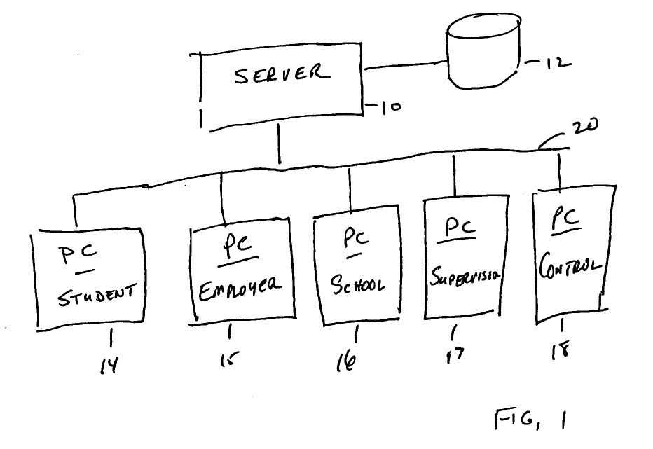

These programs can, and preferably are, organized into a curriculum for which credit can be given. For example, the following curriculum can be offered: 3 credits of Self Improvement Science Psychology; 3 credits of Meditation, Yoga, Tai Chi and other Physical Arts; 3 credits of Cosmeceutical Sciences; 3 credits of Self Improvement Techniques, including speech therapy, fashion for job training, writing improvement and organization; 3 credits on Stress Management, focusing techniques, and actual techniques of massage therapy, acupuncture, herbal medicine; 3 credits on Nutrition and 2 credits on Assessment analysis in the program and during life experience. Such a curriculum would constitute a 20 credit self-improvement program. These courses as well as others related to the self-improvement arts. The self-improvement program can also include medical procedures, such as plastic surgery under appropriate medical care, where the self-assessment and psychological components indicate that such procedures would be beneficial. FIG. 1 illustrates a networked computer system in accordance with a first aspect of the present invention. A server 10 is connected to a memory device 12. The memory device 12 can be a database. A plurality of personal computers 14 to 18 are connected to the server 10 via a network 20. The server 10 maintains information about the self-improvement program, including information about the courses and information about the previously described assessments.

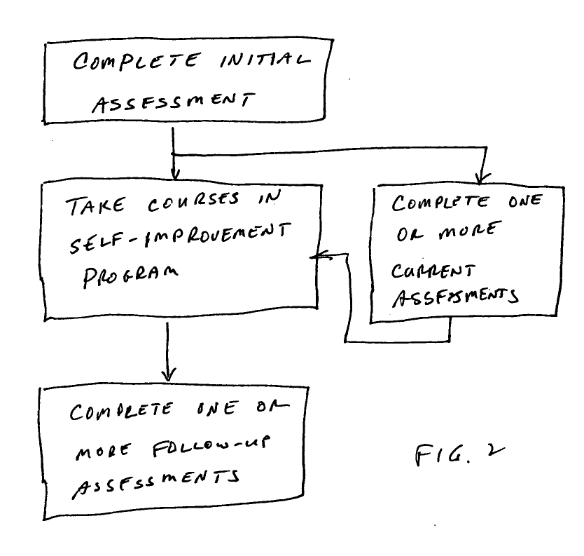

FIG. 2 illustrates a process in accordance with another aspect of the present invention. In step 30, an initial assessment is completed. The assessment can be completed on any of the personal computers 14 to 18 or it can be completed by a person and the data entered into any of the personal computers 14 to 18. Further, the assessment can be a form stored locally on any of the personal computers 14 to 18 or it can be stored at the server 10 and downloaded to the personal computers 14 to 18. The assessment can be completed by a student. It can also be completed by a third party. The third party can be the student's employer, the student's school or any other person in a supervisory role with respect to the student. The assessments can be completed directly on the computer system on the computers 14 to 18 or they can be completed on a paper or other form and then entered into the computer system at a later date. The results from the assessments are preferably stored in the memory 12 maintained by the server 12.

In step 32, the student takes courses being offered in the program for self-improvement. These courses may take one to two years to complete. During the time the student is taking the courses, one or more current assessments are completed in step 34. Once again, the current assessment can be completed by the student and/or by a third party. Once all of the courses in the program are completed, a follow-up assessment is immediately completed in step 36. Step 36 also involves a number of follow-up assessments once the courses in the self-improvement program are completed.

Each of these assessments can be completed by a control group to measure the performance of the program for self-improvement. This information is preferably transferred to the server 10 and stored in the memory 12.

The results from each assessment completed in steps 30, 34 and 36 are preferably transferred to the server 10 and stored in the memory 12. This allows the assessment information to be retrieved at any time and used to analyze progress of the student.

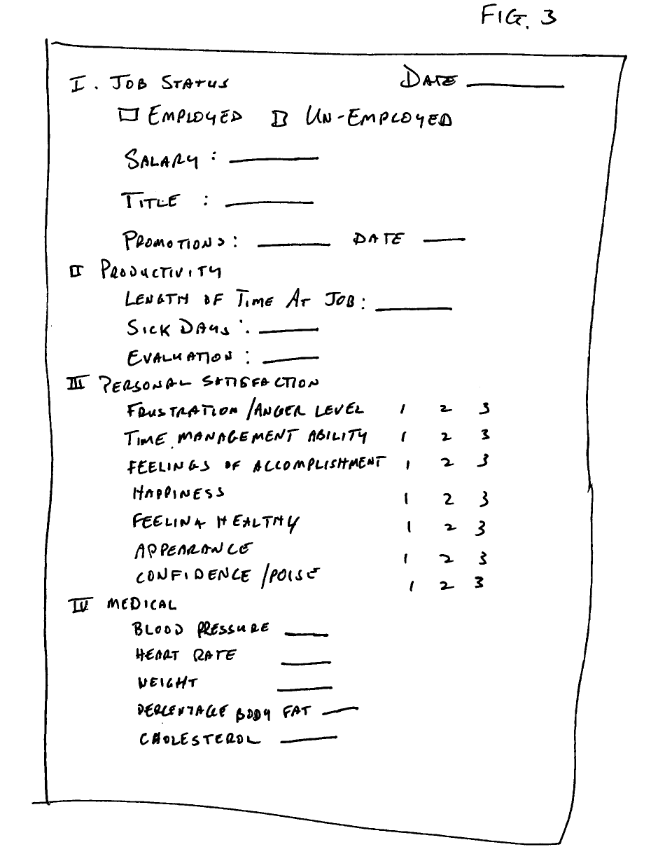

FIG. 3 illustrates an exemplary assessment form in accordance with the present invention which may completed in paper form or on a computer, as previously described. The assessment is preferably dated. In a first section, information about the student's job is completed. The information obtained includes employment status, salary, title and promotions, including the date thereof.

In a second section, information about the student's productivity is obtained. This information includes the length of time at a job, the number of sick days taken and the employer's evaluation. In a third section, information about the student's personal satisfaction is preferably obtained. This information includes a rating of the frustration/anger level, the ability to manage time, a rating of feelings of accomplishment, a rating of happiness, a rating of how healthy a person feels or appears, an appearance rating and a confidence rating. The assessment form can be completed by a student in which case the assessment is a self-assessment. It can also be completed by a third party, in which case it is an assessment of how the student is perceived.

In a fourth section of the assessment form, medical tests are performed on the student and information concerning blood pressure, heart rate, weight, percentage body fat and cholesterol levels are entered.

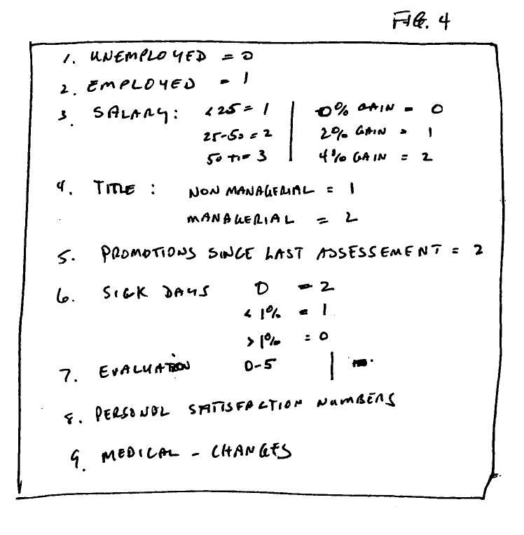

FIG. 4 illustrates a determination of a composite score from an assessment form in accordance with a further aspect of the present invention. Each time an assessment is completed, a composite score is preferably generated. For example, if the student is employed at the time of the completion of the assessment, 1 point is given. If the student's salary is within the indicated ranges, the indicated amount of points is given, or if the assessment is a current assessment or a follow-up assessment, then the number of points depends on the percentage increase in salary. Similarly, as indicated in FIG. 4, 1 point is given if the student has a non-managerial title and 2 points are given if the student has a managerial title. Points are given if the student has received a promotion since the last assessment. The number of sick days is evaluated and points awarded based on the number of sick days, as indicated. The employer's evaluation, preferably on a scale of 1-5 is considered and points awarded based on the evaluation. The personal satisfaction numbers directly from the form are added. Finally, points are determined based on the results of the medical test. If blood pressure, heart rate, weight, percentage body fat and cholesterol are within acceptable levels then 1 point is added for each item. All of the points are added to arrive at a composite number.

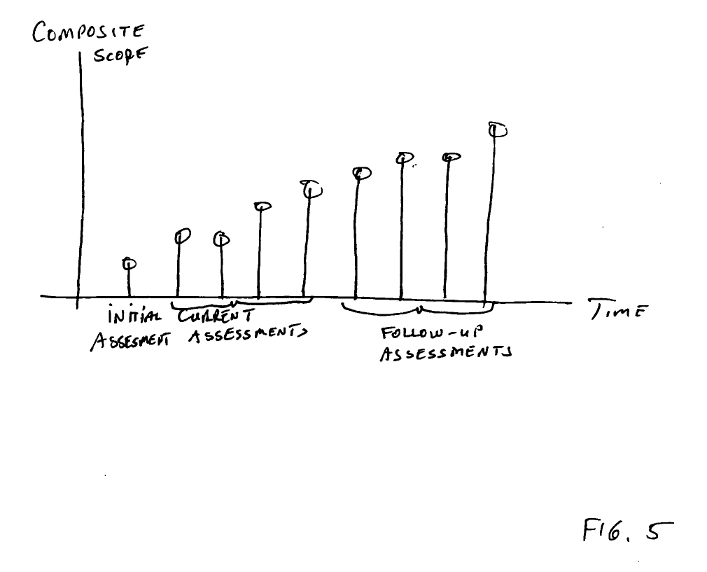

FIG. 5 illustrates a display of composite scores from a plurality of assessments taken over time. As is illustrated, it is expected that the composite scores will show steady improvement as the self-improvement course is taken and completed. If there is no improvement, then there is an issue that must be addressed.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A method of improving an individual through a program of improvement courses, comprising:
completing an initial assessment on a computer system prior to the individual starting the program of improvement courses and storing the completed initial assessment in a memory on the computer system;
taking the program of improvement courses; and
completing one or more current assessments on the computer system while taking the program of improvement courses and storing the completed one or more current assessments in the memory.

2. The method as claimed in claim 1, wherein the initial assessment and the one or more current assessments are completed by the individual.

3. The method as claimed in claim 1, wherein the initial assessment and the one or more current assessments are completed by a third party.

4. The method as claimed in claim 3, wherein the third party is the individual's employer.

5. The method as claimed in claim 1, further comprising modifying the program of improvement courses based on the one or more current assessments.

6. The method as claimed in claim 1, comprising:
computing an initial composite score from the completed initial assessment and storing the initial composite score in the memory; and
computing a current composite score from each of the one or more current assessments and storing each of the current composite scores in the memory.

7. The method as claimed in claim 6, comprising displaying the initial composite score and the current composite scores to determine progress of the individual.

8. The method as claimed in claim 1, wherein the program of improvement courses includes courses relating to Self Improvement Arts.

9. The method as claimed in claim 1, wherein the program of improvement courses includes courses in physical arts, cosmeceutical sciences, nutrition, speech, writing, time management, stress management, focusing techniques and massage therapy.

10. The method as claimed in claim 9, wherein the initial assessment and the current assessment includes knowledge tests, physical tests, medical tests and psychological tests.

11. The method as claimed in claim 1, comprising completing one or more follow-up assessments on the computer after finishing the program of improvement courses and storing the completed one or more follow-up assessments in the memory.

12. The method as claimed in claim 11, comprising computing a follow-up composite score from each of the one or more follow-up assessments and storing each of the follow-up composite scores in the memory.

13. The method as claimed in claim 12, comprising displaying the initial composite score, the current composite scores and the follow-up composite scores to determine progress of the individual.

14. The method as claimed in claim 11, wherein the initial assessment, the one or more current assessments and the one or more follow-up assessments are completed by the individual.

15. The method as claimed in claim 11, wherein the initial assessment, the one or more current assessments and the one or more follow-up assessments are completed by a third party.

16. The method as claimed in claim 15, wherein the third party is the individual's employer.

17. A method of improving an individual through a program of improvement courses, comprising:
completing an initial assessment prior to the individual starting the program of improvement courses;
taking the program of improvement courses; and
completing one or more current assessments while taking the program of improvement courses.

18. The method as claimed in claim 17, wherein the initial assessment and the one or more current assessments are completed by the individual.

19. The method as claimed in claim 17, wherein the initial assessment and the one or more current assessments are completed by a third party.

20. The method as claimed in claim 18, wherein the third party is the individual's employer.

21. The method as claimed in claim 17, comprising completing one or more follow-up assessments after finishing the program of improvement courses.

22. The method as claimed in claim 21, comprising comparing the initial assessment, the one or more current assessments and the one or more follow-up assessments to determine progress of the individual.
